(19) United States
(12) Patent Application Publication
(10) Pub. No.: US 2012/0069100 A1
(43) Pub. Date: Mar. 22, 2012

(54) Ink-jet Print Head with Fast-acting Valve

(76) Inventors: Simon K. Poruthoor, Alpharetta, GA (US); Mike Houston, Roswell, GA (US)

(21) Appl. No.: 12/883,913

(22) Filed: Sep. 16, 2010

(51) Int. Cl. B41J 2/045

(52) U.S. Cl. 347/68

(57) ABSTRACT

Disclosed herein, a print head includes a reservoir, wherein the reservoir maintains fluid at a high hydrostatic pressure; a passage to receive the fluid from the reservoir, the passage including a fluid droplet ejection orifice; and a piezoelectric member positioned adjacent said passage, wherein the piezoelectric member may be activated to prevent flow of fluid through the passage. The piezoelectric member may be activated at a frequency greater than about 40 kilohertz, desirably greater than about 50 kilohertz, and even more desirably greater than about 100 kilohertz.

### BACKGROUND OF THE INVENTION

Drop-on-demand print head systems operate by jetting ink in the form of small droplets at high frequencies. The speed of printing is limited by the frequency at which the droplets can be jetted. One method of jetting ink involves pumping or energizing the ink by contacting the ink with an oscillating piezoelectric member that operates at very high frequencies. Though piezoelectric members are capable of oscillating at frequencies of up to 150 kilohertz (KHz), droplet formation occurs at a frequency of up to only about 40 KHz, which limits the speed at which printing occurs. Higher frequency droplet formation would provide greater control over speed and accuracy of droplet placement on a printed substrate. Thus, there exists a need to increase the frequency of ink droplet formation in drop-on-demand print head systems.

### SUMMARY OF THE INVENTION

In one embodiment, a print head includes a reservoir, wherein the reservoir maintains fluid at a high hydrostatic pressure; a passage to receive the fluid from the reservoir, the passage including a fluid droplet ejection orifice; and a piezoelectric member positioned adjacent said passage, wherein the piezoelectric member may be activated to prevent flow of fluid through the passage. The piezoelectric member may be activated at a frequency greater than about 40 kilohertz, desirably greater than about 50 kilohertz, and even more desirably greater than about 100 kilohertz. The reservoir may be kept at high hydrostatic pressure by applying air or other fluid above the fluid in the reservoir by a pressure applying device. The piezoelectric member may be covered with an elastic seal to minimize seepage when the piezoelectric member is in a closed position. In some embodiments, one or more piezoelectric members may be positioned in the passage to cooperatively control flow of fluid through the passage.

In another embodiment, a method of jetting fluid from a print head includes the steps of maintaining fluid in a reservoir at a high pressure and in fluid communication with a passage; and, activating a piezoelectric member adjacent the passage to open and close the passage. The piezoelectric member may be activated at a frequency greater than about 40 kiloHertz, desirably greater than about 50 kilohertz, and even more desirably greater than about 100 kilohertz. The method may further include the step of generating droplets at a frequency greater than about 40 kilohertz, desirably greater than about 50 kilohertz, and even more desirably greater than about 100 kilohertz. Further, the method may further include the step of transferring ink from the ink reservoir through the passage to an ink droplet ejection orifice. The reservoir may be kept at high hydrostatic pressure by applying air above the fluid by a pressure applying device. To reduce seepage, the piezoelectric member may be covered with an elastic seal. In some embodiments, one or more piezoelectric members may be positioned in the passage to cooperatively control flow of fluid through the passage.

In another embodiment, a printing apparatus includes a substrate feed device for feeding a substrate within the printing apparatus; and a print head including a reservoir, wherein the reservoir maintains fluid at a high hydrostatic pressure; a passage to receive the fluid from the reservoir, the passage including a droplet ejection orifice; and a piezoelectric member positioned adjacent said passage, wherein the piezoelectric member may be activated to open and close the passage. The piezoelectric member may be activated at a frequency greater than about 40 kilohertz, desirably greater than about 50 kilohertz, and even more desirably greater than about 100 kilohertz. The reservoir may be kept at the high hydrostatic pressure by applying air above the fluid by a pressure applying device. The piezoelectric member may be covered with an elastic seal.

Other features and aspects of the present invention are described in more detail below.

### BRIEF DESCRIPTION OF THE DRAWINGS

A full and enabling disclosure of the present invention, including the best mode thereof, directed to one of ordinary skill in the art, is set forth more particularly in the remainder of the specification, which makes reference to the appended figures in which:

FIG. 1 illustrates an ink-jet print head according to an embodiment of the present invention;

FIG. 2 is a computational fluid flow model with the valve closed;

FIG. 3 depicts pressure contours with the valve closed;

FIG. 4 depicts a close up view of the pressure contours in the valve throat with the valve in the closed position;

FIG. 5 depicts velocity vectors for the valve in the closed position;

FIG. 6 depicts the valve computational mesh in the open position;

FIG. 7 depicts pressure contours with the valve open;

FIG. 8 depicts a close up view of pressure contours with the valve open;

FIG. 9 depicts the velocity vectors with the valve open;

FIG. 10 depicts a close up view of the velocity vectors for the valve in the open position.

Repeat use of reference characters in the present specification and drawings is intended to represent same or analogous features or elements of the invention.

### DETAILED DESCRIPTION OF REPRESENTATIVE EMBODIMENTS

Reference now will be made in detail to various embodiments of the invention, one or more examples of which are set forth below. Each example is provided by way of explanation, not limitation of the invention. In fact, it will be apparent to those skilled in the art that various modifications and variations may be made in the present invention without departing from the scope or spirit of the invention. For instance, features illustrated or described as part of one embodiment, may be used on another embodiment to yield a still further embodiment. Thus, it is intended that the present invention cover such modifications and variations.

Generally speaking, the present invention is directed to improving the performance of ink-jet print heads in an ink-jet apparatus in high frequency usage conditions.

The ink-jet apparatus may include a print head, an ink reservoir, and other peripheral apparatus. The print head may include a plurality of individual jetting assemblies, each jetting assembly including an ink-jet chamber, a fast-acting valve, and an orifice member including an ink droplet ejection orifice. The fast-acting valve is positioned in fluid communication between the ink reservoir and the orifice member. In one embodiment, the fast-acting valve may comprise a piezoelectric member.

The ink-jet apparatus may be applied in many different applications where a liquid, which is not necessarily an ink, may be jetted from a print head device. For example, the liquid may be an ink, a polymer, a metal, a plastic, a wax, anything that is a liquid or can be liquefied, for example, by heating. The above list is only a representative list and should not be construed as limiting, in that embodiments of the invention may be applied to any substance that is jetted from a print head device onto another surface.

It will be appreciated that inks which are suitable for use in the present invention may be available in a variety of colors, and it is desirable that inks of at least two different colors are used. Furthermore, where inks of different colors are used, the resulting pattern or image formed on a substrate may be such that a single or multi-color image is produced. That is, for example, where yellow and blue inks are used, the resulting image could be green or it could be yellow and blue or it could be green, yellow and blue. Of course a variety of shades of each color is also possible to produce.

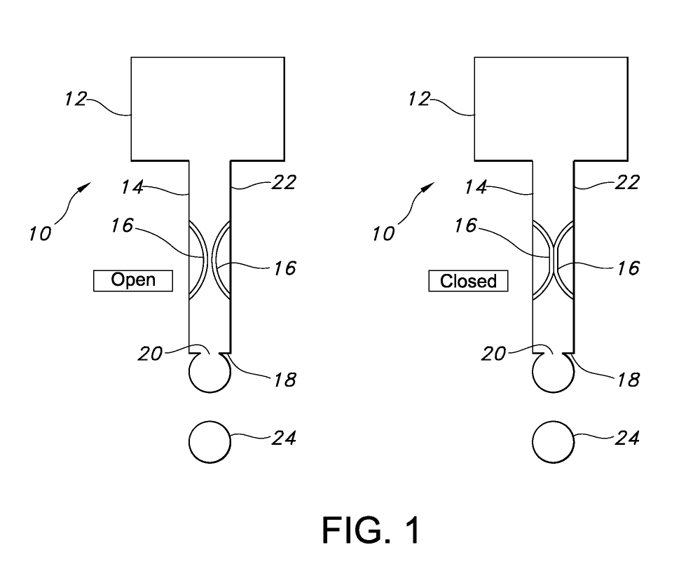

FIG. 1 illustrates two jetting assemblies 10 according to one embodiment of the present invention. The jetting assembly 10 includes a reservoir 12, a jetting chamber 14, a fast-acting valve 16, an orifice member 18, and a transducer (not shown). In one desirable embodiment, the fast-acting valve 16 includes at least one piezoelectric element 16. The jetting chamber 14 is positioned in fluid communication between the reservoir 12 and the orifice member 18. The orifice member 18 defines an orifice 20 through which fluid is ejected as a droplet 24. In some embodiments the orifice 20 is round, the orifice having a diameter ranging from about 1 to about 60 microns, desirably ranging from about 5 to about 50 microns, more desirably ranging from about 10 to about 40 microns.

The piezoelectric element 16 is positioned in the jetting chamber 14 to be capable of stopping the flow of fluid through the jetting chamber from the reservoir 12 to the orifice member 18. Desirably, the piezoelectric element 16 is positioned to directly stop the flow of fluid through the jetting chamber. One of the jetting assemblies 10 depicts the piezoelectric element 16 in an open position. The other jetting assembly 10 depicts the piezoelectric element 16 in a closed position. The transducer activates the piezoelectric element 16 from the closed position to the open position and back to the closed position in a cycle. Desirably, each cycle opening and closing the piezoelectric element 16 results in jetting an individual droplet of fluid through the orifice member. Illustratively, during a time period when no fluid flow is desired, closing of the valve 16 may prevent fluid seeping from the orifice member 18. Desirably, in the open position fluid flows directly past and in contact with the piezoelectric element 16.

In one embodiment, a single piezoelectric element 16 may be positioned in the jetting chamber 14. When in an open position, fluid will flow between the piezoelectric element 16 and a wall 22 of the jetting chamber 14. When the piezoelectric element 16 is activated to the closed position, the piezoelectric element 16 will seat against the wall 22 of the jetting chamber 14 to stop flow of fluid in the jetting chamber. In another embodiment, opposing first and second piezoelectric elements 16 may be positioned on opposing walls 22 of the jetting chamber 14. When in an open position, fluid will flow between the first and second piezoelectric members 16. When the first and second piezoelectric elements 16 are activated to the closed position, the first piezoelectric element will seat against the second piezoelectric element to stop flow of fluid in the jetting chamber 14. Other geometric arrangements using multiple piezoelectric elements 16 are possible. Desirably, the piezoelectric elements 16 are the last barrier or restriction to the flow of fluid before the fluid reaches the orifice 20.

Displacement of the piezoelectric element 16 upon activation and deactivation may range from about 1 micron to about 100 microns, more desirably from about 2 to about 80 microns, and even more desirably from about 3 to about 50 microns.

The piezoelectric element 16 may be activated at variable frequencies to provide variable droplet size. The frequency range may vary from be from about 1 KHz to full scale frequency of the valve, from about 1 KHz to about 100 KHz, from about 10 KHz to about 100 KHz, from about 20 KHz to about 100 KHz, from about 45 KHz to about 100 KHz, or from about 60 KHz to about 100 KHz. The drop sizes that may be obtained range from about 10 picoliters (pL) to about 10,000 pL, from about 20 pL to about 500 pL, or from about 40 pL to about 200 pL.

In some embodiments the jetting assembly may include a single reservoir 12, a single jetting chamber 14, a single fast-acting valve 16, a single orifice member 18, and a single transducer. In some embodiments the jetting assembly may include a plurality of devices 10, each of the devices 10 including a plurality of reservoirs 12, a plurality of jetting chambers 14, a plurality of fast-acting valves 16, a plurality of orifice members 18, and a plurality of transducers. Each of the ink-jet devices 10 may operate to selectively eject droplets of fluid from the jetting chamber 14 through the droplet ejection orifice in response to the selective energizing of the transducer.

In an embodiment of the invention, the reservoir 10 may be placed at a higher hydrostatic pressure than the jetting chamber 14. This configuration may be needed in order to prevent ink starvation, i.e., not enough ink making it into the jetting chamber 14. The higher hydrostatic pressure maintained in the reservoir 10 may be achieved in a variety of manners as will be known to those of ordinary skill in the art. In one embodiment, air may be applied above the fluid by a pressure-applying device (not shown) such as an elastic membrane. The pump is desirably capable of adjusting the pressure in the reservoir 10 according to the printing frequency. In some embodiments the fluid in the reservoir 10 will be maintained at a pressure from about 0.1 bar to about 10 bar, in some embodiments from about 0.5 bar to about 7 bar, and in some embodiments from about 1 bar to about 4 bar.

In a further embodiment of the invention, the ejection velocity of the droplet may be controlled by adjusting the applied pressure in the reservoir 10 rather than by the energy delivered to the fast-acting valve. Increasing the pressure in the reservoir 10 tends to increase the ejection velocity above the ejection velocity that can be achieved by systems for which the ejection velocity is limited by the energy delivered to the fast acting valve. Advantageously, higher ejection velocity allows a higher gap between the print head and the substrate being printed. Further, higher ejection velocity allows deeper penetration of the droplets into the substrate being printed. Higher ejection velocity also allows printing of substrates with more varied surface evenness. For example, higher ejection velocity may enhance printability of fibrous substrates that have fibers extending from the substrate surface. Droplet velocities achievable range from about 1 meter/second (m/s) to about 100 m/s, from about 5 m/s to about 50 m/s, or from about 10 m/s to about 40 m/s. The gap between the print head orifice and the substrate may range from about 1 millimeter (mm) to about 50 mm, or from about 2 mm to about 20 mm.

A further advantage that results from controlling ejection velocity by adjusting the applied pressure in the reservoir 10 is that the droplet jetting frequency can be maintained independently from the dynamic viscosity of the jetted fluid. This means liquids having a relatively wide range of dynamic viscosities may be jetted. The jetted fluid may have a suitable dynamic viscosity ranging from about 1 centipoise (cp) to about 100 cp, from about 1 cp to about 50 cp, or from about 5 cp to about 30 cp. These ranges compare favorably with the ranges of dynamic viscosities suitable for systems which use piezoelectric crystals to supply energy to the system, as those systems preferable operate in a range of about 10 to about 12 cp. Dynamic viscosity of the jetted liquid may be measured according to test method ASTM D7042-04 at 40 degrees Celsius.

As suggested above, the method of the present invention includes the step of providing a substrate upon which the discharged ink droplets may form discrete droplets or segments thereon. The substrate may be fed through a printing apparatus on a substrate feed device for feeding the substrate through the printing apparatus. While it is desirable in at least one embodiment that the substrate be a porous material, and more desirably a polyolefin, the methods and processes of the present invention, contemplate the use of any suitable porous or non-porous material. The suitability of a particular material may depend, at least in part, on the inks being used in conjunction therewith. Exemplary materials include, but are not limited to, wovens, nonwovens, papers, foams, films, tissues, metals, plastics, glass, laminates, and generally any surface of any substrate or product which is capable of having inks applied thereto. It is further contemplated that the material may comprise or be incorporated in a flexible packaging product, an article of clothing, a health care product, a personal care product, one or more components thereof, and the like.

As used herein the term “nonwoven” means a web having a structure of individual fibers, filaments or threads which are interlaid, but not in an identifiable manner as in a knitted fabric. Nonwoven fabrics or webs have been formed from many processes such as for example, meltblowing processes, spunbonding processes, and bonded carded web processes. The term “spunbonding process” refers to a process for forming small diameter fibers by extruding molten thermoplastic material as filaments from a plurality of fine, usually circular capillaries of a spinneret with the diameter of the extruded filaments then being rapidly reduced as by, for example, in U.S. Pat. No. 4,340,563 to Appel et al., and U.S. Pat. No. 3,692,618 to Dorschner et al., U.S. Pat. No. 3,802,817 to Matsuki et al., U.S. Pat. Nos. 3,338,992 and 3,341,394 to Kinney, U.S. Pat. No. 3,502,763 to Hartman, and U.S. Pat. No. 3,542,615 to Dobo et al. Spunbond fibers are generally not tacky when they are deposited onto a collecting surface. Spunbond fibers are generally continuous and have average diameters (from a sample of at least 10) larger than 7 microns, more particularly, between about 10 and 20 microns. The term “meltblowing process” means the process of forming fibers by extruding a molten thermoplastic material through a plurality of fine, usually circular, die capillaries as molten threads or filaments into converging high velocity, usually hot, gas (e.g. air) streams which attenuate the filaments of molten thermoplastic material to reduce their diameter, which may be to microfiber diameter. Thereafter, the meltblown fibers are carried by the high velocity gas stream and are deposited on a collecting surface to form a web of randomly dispersed meltblown fibers. Such a process is disclosed, for example, in U.S. Pat. No. 3,849,241 to Butin et al. Meltblown fibers are microfibers which may be continuous or discontinuous, are generally smaller than 10 microns in average diameter, and are generally tacky when deposited onto a collecting surface.

As used herein, the term “personal care product” means diapers, training pants, swim wear, absorbent underpants, baby wipes, adult incontinence products, sanitary wipes, wet wipes, feminine hygiene products, wound dressings, nursing pads, time release patches, bandages, mortuary products, veterinary products, hygiene and absorbent products and the like.

### Computer Modeling

Computer modeling of an ink jet nozzle was performed to demonstrate practicality of the invention.

Steady state two-dimensional computational fluid dynamics models of the valve in three operating positions were built using ANSYS FLUENT 12.0 (available from Ansys, Inc. of Canonsburg, Pa.)—closed, half open and fully open to represent the valve operating extremes.

An inlet pressure of 2 bar was chosen for the ink inlet boundary condition, with atmospheric pressure for the outlet.

Internal dimensions of the valve were estimated based on expected valve travel consistent with commercially available piezoelectric cells, streamlined entry and exit geometry was then added to produce smooth, low turbulence flow.

The valve dimensions used were: throat—20 microns, inlet—40 microns, outlet—15 microns, with an overall length of 720 microns.

The operating temperature was assumed to be ambient—70 deg F. with no heat transfer into or out of the model.

Reynolds number calculations indicated that the flow field would be fully laminar.

An ink viscosity of 50 centipoise was selected for the model.

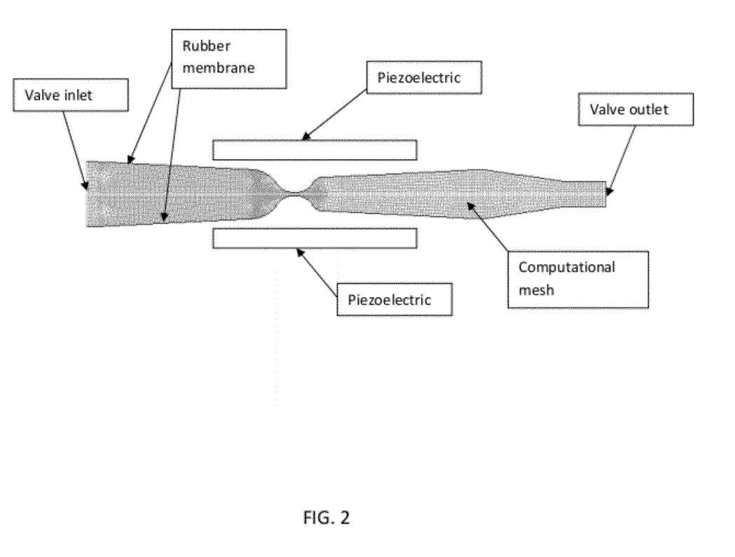

FIG. 2 is a computational mesh of the fluid flow model with the valve closed.

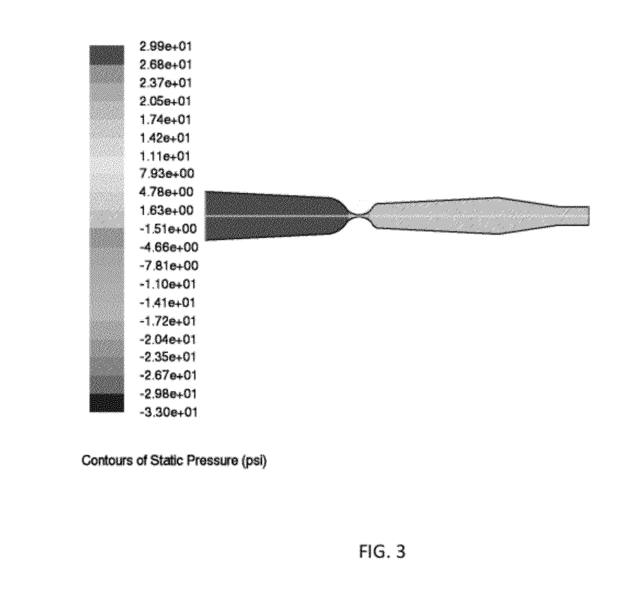

FIG. 3 shows pressure contours with the valve closed; 2 bar upstream pressure (dark) and zero (atmospheric) pressure (light) at the outlet.

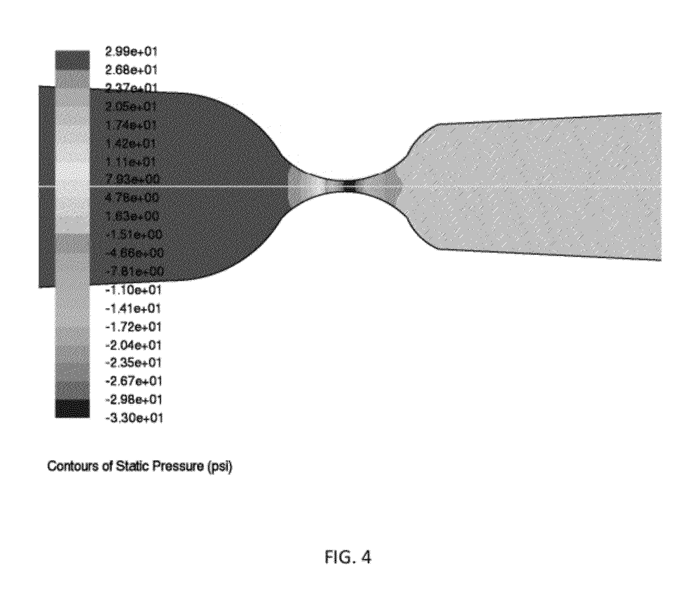

FIG. 4 shows a close up view of the pressure contours in the valve throat with the valve in the closed position. It is noted that valve throat is modeled slightly open to avoid computational discontinuities in the throat area.

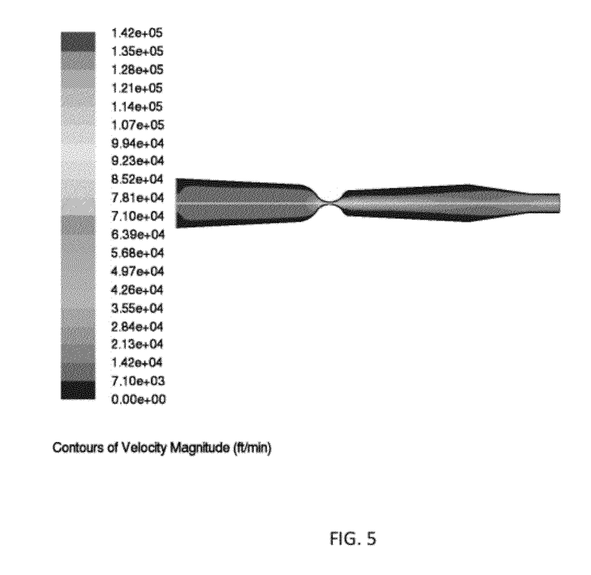

FIG. 5 shows velocity vectors for the valve in the closed position—again the valve slightly open to avoid computational discontinuities. Velocity at the wall is zero, while away from the wall is essentially zero. The velocity vectors indicate the downstream walls can be moved closer together without impact on the flow profile—this would result in better transient performance.

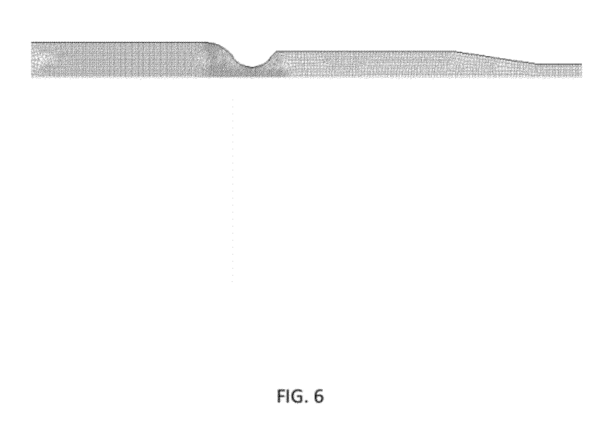

FIG. 6 shows the valve computational mesh in the open position—one half with an axis of symmetry shown.

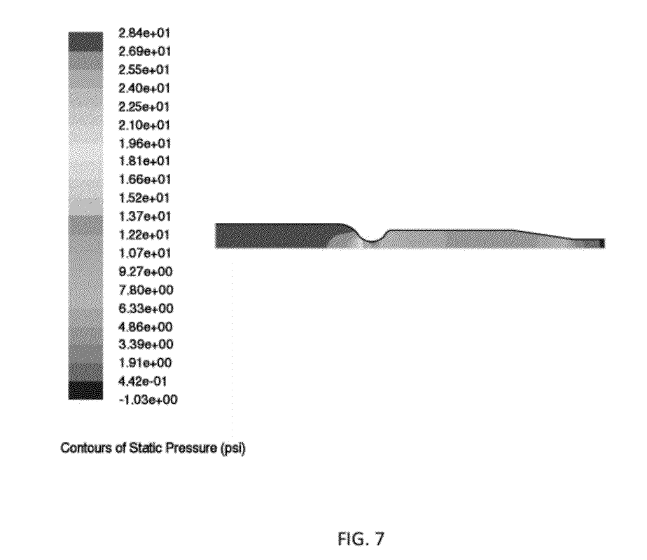

FIG. 7 shows pressure contours with the valve open. Pressure is high (dark) upstream of the valve, lower (light) downstream of the valve, and essentially zero at the exit.

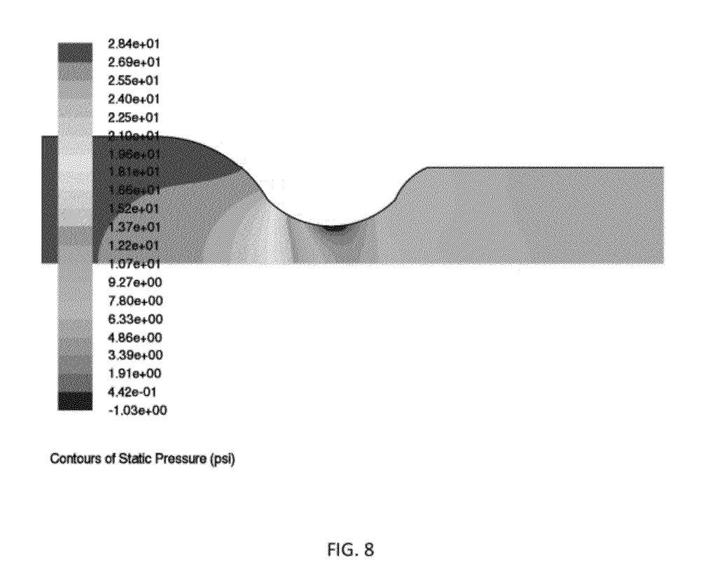

FIG. 8 shows a close up view of pressure contours with the valve open.

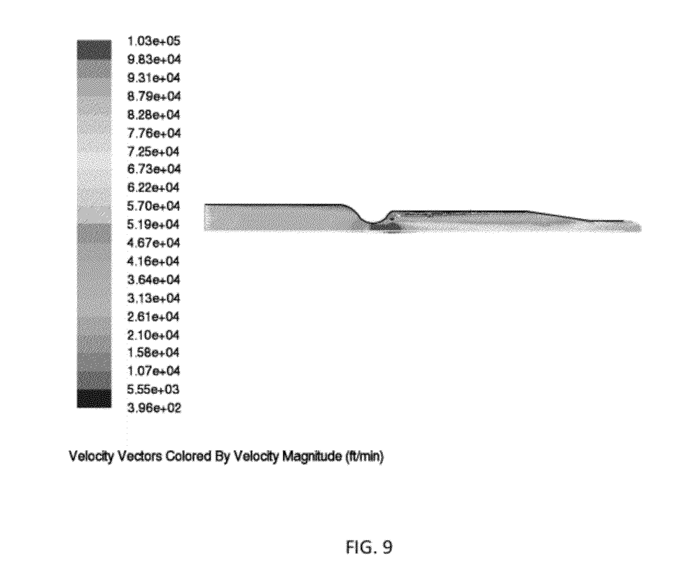

FIG. 9 shows the velocity vectors with the valve open. Notably, the velocity is very high where the fluid moves through the valve, then slowing down as it moves downstream.

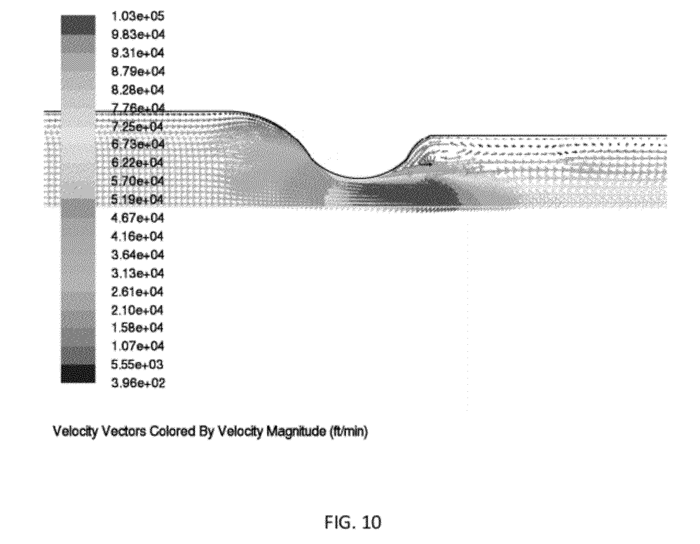

FIG. 10 shows a close up view of the velocity vectors for the valve in the open position—the downstream valve geometry requires modification to eliminate the vortex forming immediately downstream from the valve throat.

The computer model of the ink jet nozzle predicted an acceptable ink flow profile at normal operating pressures with a typical ink. The flow profile of the ink through the valve appears reasonable and the valve profile should be feasible to manufacture. The computer model further showed that the valve geometry may be streamlined downstream from the valve throat to prevent vortex formation and promote smooth ink flow downstream to the orifice. Streamlining the downstream flow profile will also improve the transient performance and should provide reliable drop formation.

While the description above refers to particular embodiments of the present invention, it should be readily apparent to people of ordinary skill in the art that a number of modifications may be made without departing from the spirit thereof. The accompanying claims are intended to cover such modifications as would fall within the true spirit and scope of the invention. The presently disclosed embodiments are, therefore, to be considered in all respects as illustrative and not restrictive, the scope of the invention being indicated by the appended claims rather than the foregoing description. All changes that come within the meaning of and range of equivalency of the claims are intended to be embraced therein.

1. A print head comprising: a reservoir, wherein the reservoir maintains fluid at a high hydrostatic pressure; a passage to receive the fluid from the reservoir, the passage including a fluid droplet ejection orifice; and at least one piezoelectric member positioned adjacent said passage, wherein the piezoelectric member may be activated to prevent flow of fluid through the passage.

2. The print head of claim 1, wherein the piezoelectric member is activated at a frequency greater than about 40 kilohertz, desirably greater than about 50 kilohertz, and even more desirably greater than about 100 kilohertz.

3. The print head of claim 1, wherein the reservoir is kept at the hydrostatic pressure from about 0.1 bar to about 10 bar by applying air above the fluid with a pressure applying device.

4. The print head of claim 1, wherein the piezoelectric member is covered with an elastic seal.

5. The print head of claim 1, wherein two or more piezoelectric members are positioned adjacent said passage, and wherein the two or more piezoelectric members may be activated to cooperatively prevent flow of fluid through the passage.

6. The print head of claim 1 wherein the orifice has a diameter ranging from about 1 to about 30 microns.

7. A method of jetting fluid from a print head comprising: maintaining fluid in a reservoir at a high pressure and in fluid communication with a passage; and, activating at least one piezoelectric member adjacent the passage to open and close the passage.

8. The method of claim 7, wherein the piezoelectric member is activated at a frequency greater than about 40 kilohertz, desirably greater than about 50 kilohertz, and even more desirably greater than about 100 kilohertz.

9. The method of claim 7, further comprising the step of generating droplets at a frequency greater than about 40 kilohertz, desirably greater than about 50 kilohertz, and even more desirably greater than about 100 kilohertz.

10. The method of claim 7, further including transferring ink from the ink reservoir through the passage to an ink droplet ejection orifice.

11. The method of claim 7, wherein two or more piezoelectric members may be activated to cooperatively prevent flow of fluid through the passage.

12. The method of claim 7, wherein the piezoelectric member is covered with an elastic seal.

13. The method of claim 7, wherein the fluid in the reservoir is kept at a hydrostatic pressure from about 0.1 bar to about 10 bar.

14. The method of claim 7 wherein the passage includes an orifice having a diameter ranging from about 1 to about 30 microns.

15. A printing apparatus comprising: a substrate feed device for feeding a substrate within the printing apparatus; and print head including a reservoir, wherein the reservoir maintains fluid at a high hydrostatic pressure; a passage to receive the fluid from the reservoir, the passage including a droplet ejection orifice; and at least one piezoelectric member positioned adjacent said passage, wherein the piezoelectric member may be activated to open and close the passage.

16. The printing apparatus of claim 15, wherein the piezoelectric member is activated at a frequency greater than about 40 kilohertz, desirably greater than about 50 kilohertz, and even more desirably greater than about 100 kilohertz.

17. The printing apparatus of claim 15, wherein two or more piezoelectric members are positioned adjacent said passage, and wherein the two or more piezoelectric members may be activated to cooperatively prevent flow of fluid through the passage.

18. The printing apparatus of claim 15, wherein the piezoelectric member is covered with an elastic seal.

19. The printing apparatus of claim 15, wherein the reservoir is kept at a hydrostatic pressure from about 0.1 bar to about 10 bar.

20. The printing apparatus of claim 15 wherein the orifice has a diameter ranging from about 1 to about 30 microns.
